(19) United States
(12) Patent Application Publication
(10) Pub. No.: US 2026/0163978 A1
(43) Pub. Date: Jun. 11, 2026

(54) APPARATUSES AND METHODS FOR FACILITATING AI-ASSISTED VOICE AND MEDIA SERVICES

(71) Applicants: AT&T Intellectual Property I, L.P., Atlanta, GA (US); Interwise Ltd., Ben-Gurion Airport (IL)

(72) Inventors: Amit Kumar Sheoran, Raritan, NJ (US); James Poulin, SEATTLE, WA (US); Mun May Tee, SAN FRANCISCO, CA (US); Nathan Folkman, Carcavelos (PT); Vimal Patel, Morganville, NJ (US); James Ibezim, Ocean, NJ (US); Prince Paulraj, Coppell, TX (US); Antoine Diffloth, Sammamish, WA (US); Chaoxin Qiu, Austin, TX (US); Gil From, Ottawa (CA); Rahul Bhise, Bothell, WA (US); Aparna Kulkarni, Bothell, WA (US); Senmiao Liu, Skillman, NJ (US); Anh Minh Dinh, Brooklyn, NY (US); Austin Thomas, Bothell, WA (US); Oz Cooper, Na’ale (IL); Diego Bustamante, Fairfield, NJ (US); Kelly Baumeister, North Bend, WA (US); Idan Giloh, Herzliya (IL); Ashish Harshe, Sammamish, WA (US); Priyanka Prakash, Kirkland, WA (US); Vijay Gopalakrishnan, Edison, NJ (US)

(73) Assignees: AT&T Intellectual Property I, L.P., Atlanta, GA (US); Interwise Ltd., Ben-Gurion Airport (IL)

(21) Appl. No.: 18/974,970

(22) Filed: Dec. 10, 2024

(51) Int. Cl. H04M 3/51

(52) U.S. Cl. CPC H04M 3/5166

(57) ABSTRACT

Aspects of the subject disclosure may include, for example, obtaining a request for a communication service including a voice call, determining, based on the obtaining of the request, that an artificial intelligence (AI) agent is to support the communication service, and embedding, based on the determining, at least a first AI agent within a resource of a communication network to provide support for the communication service. Other embodiments are disclosed.

### FIELD OF THE DISCLOSURE

The subject disclosure relates to apparatuses and methods for facilitating AI-assisted voice and media services.

### BACKGROUND

Voice-enabled assistants have been utilized in recent years to provide data or information in response to a query. For example, a user may pose a question like, “[Insert nickname of the voice-enabled assistant], what is the weather going to be like today?” Based on an inferred location, the voice-enabled assistant typically provides a response, e.g., “It is going to be a high temperature of 75 degrees Fahrenheit and a low temperature of 44 degrees Fahrenheit in [insert location].” While generally simplifying a user's life by enabling a conveyance of data or information in a voice-driven, hands-free manner, the nature of the response and functionality that is supported by voice-enabled assistants is generally of limited value. For example, experience has demonstrated that voice-enabled assistants typically lack knowledge or sophistication to render assistance or support beyond very simple inquiries of the type/kind mentioned above.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2I are diagrams illustrating exemplary scenarios where an artificial intelligence (AI) based agent or assistant may support a communication service, session, or application in accordance with aspects of this disclosure.

FIG. 2J depicts a block diagram of a system in accordance with aspects of this disclosure.

FIG. 2K depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for facilitating an artificial intelligence (AI) based agent or assistant in respect of one or more communication services or sessions. Other embodiments are described in the subject disclosure.

One or more aspects of the subject disclosure include, in whole or in part, obtaining a request for a communication service including a voice call; determining, based on the obtaining of the request, that an artificial intelligence (AI) agent is to support the communication service; and embedding, based on the determining, at least a first AI agent within a resource of a communication network to provide support for the communication service.

One or more aspects of the subject disclosure include, in whole or in part, invoking a first artificial intelligence (AI) agent in respect of a first resource of a first carrier to support a communication service for a first user; and based on the invoking, interacting, via the first AI agent, with a second user as part of the communication service.

One or more aspects of the subject disclosure include, in whole or in part, obtaining, by a processing system including a processor, an indication of a first voice call initiated by a first user and directed to at least a second user; invoking, by the processing system and based on the obtaining of the indication of the first voice call, an artificial intelligence (AI) agent to answer the first voice call on behalf of the second user; determining, by the processing system and based on the invoking of the AI agent to answer the first voice call, a first purpose of the first user in initiating the first voice call; determining, by the processing system, that the first purpose satisfies a preference of the second user; and notifying, by the processing system and based on the determining that the first purpose satisfies the preference of the second user, a communication device of the second user of the first voice call.

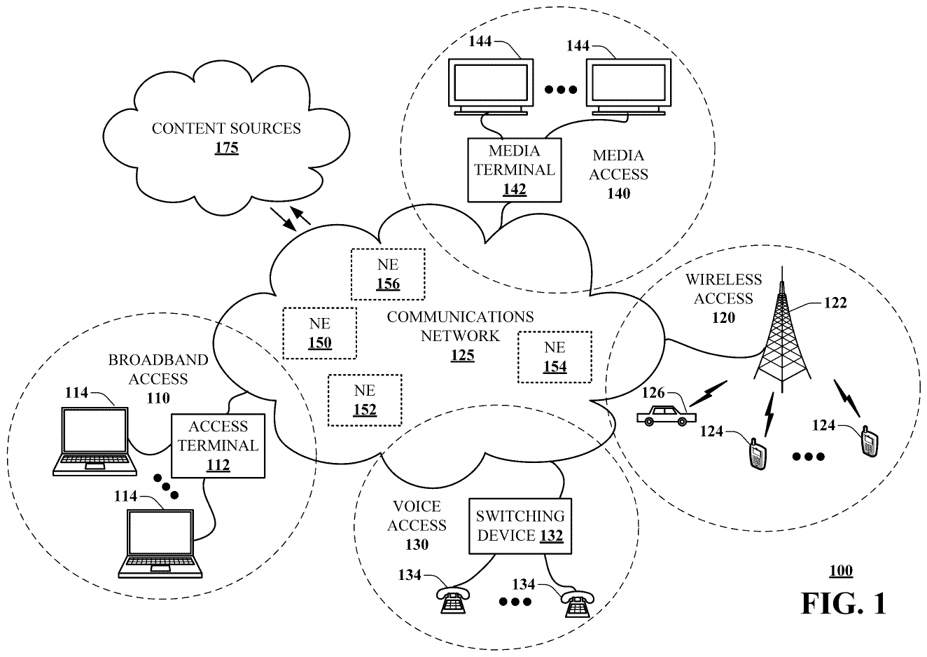

Referring now to FIG. 1, a block diagram is shown illustrating an example, non-limiting embodiment of a system 100 in accordance with various aspects described herein. For example, the system 100 can facilitate in whole or in part obtaining a request for a communication service including a voice call, determining, based on the obtaining of the request, that an artificial intelligence (AI) agent is to support the communication service, and embedding, based on the determining, at least a first AI agent within a resource of a communication network to provide support for the communication service. The system 100 can facilitate in whole or in part invoking a first artificial intelligence (AI) agent in respect of a first resource of a first carrier to support a communication service for a first user, and based on the invoking, interacting, via the first AI agent, with a second user as part of the communication service. The system 100 can facilitate in whole or in part obtaining, by a processing system including a processor, an indication of a first voice call initiated by a first user and directed to at least a second user, invoking, by the processing system and based on the obtaining of the indication of the first voice call, an artificial intelligence (AI) agent to answer the first voice call on behalf of the second user, determining, by the processing system and based on the invoking of the AI agent to answer the first voice call, a first purpose of the first user in initiating the first voice call, determining, by the processing system, that the first purpose satisfies a preference of the second user, and notifying, by the processing system and based on the determining that the first purpose satisfies the preference of the second user, a communication device of the second user of the first voice call.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure may include an artificial intelligence (AI) assistant/agent that may be used to provide support for various communication services and applications in conjunction with a communication network or system. In some embodiments, an AI agent may process (e.g., intercept, receive, initiate) voice or video calls (and other multimedia services) on behalf of a user. Multimodal data in the form of, e.g., text, audio, video, augmented reality/virtual reality (AR/VR), etc., may be included or supported as part of one or more communication services or sessions.

In some embodiments an AI agent may be bound to a particular user or identifier, such as a Mobile Station International Subscriber Directory Number (MSISDN) (informally, telephone number). By virtue of such a binding, a user may obtain flexibility, as any network/system carrier or operator may be able to host the AI agent for/from another network/system carrier or operator. In this respect, if the user opts/elects to change carriers/operators, an application programming interface (API), or the like, may be utilized to transfer the AI agent from the first, originating carrier/operator to the new, second carrier/operator.

Aspects of an AI agent may be based on one or more models. For example, in some embodiments an AI agent may (initially) be established with a set of default rules or functions/functionalities (which may be representative of a typical or average user). A user may have an option to select particular rules or functions/functionalities, which may be based at least in part on an expression of user preferences. In some embodiments, the AI agent may gain knowledge of the user preferences based on use or experience, which is to say that the AI agent may be trained, over time, based on interactions with the user and the outside world. In some embodiments, a user may opt/elect to enable other users (e.g., other MSISDNs) to interact with, or train, the AI agent on behalf of the user (as potentially subject to authentication/verification of the other users).

In some embodiments, an AI agent may have access to a rich set of data or information to facilitate decision-making processes or logic. By way of demonstration, functions/functionalities supported by an AI agent may be based in part on an analysis of location data, environmental or sensor data (which may be based on a use of one or more Internet of Things [IoT] devices), communication network/system data (e.g., radio access network data, core network data, etc.), user schedules or calendars, etc.

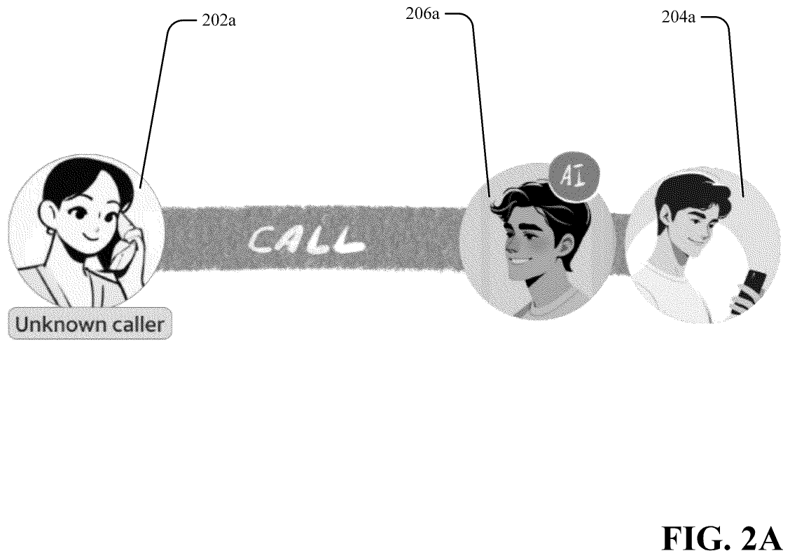

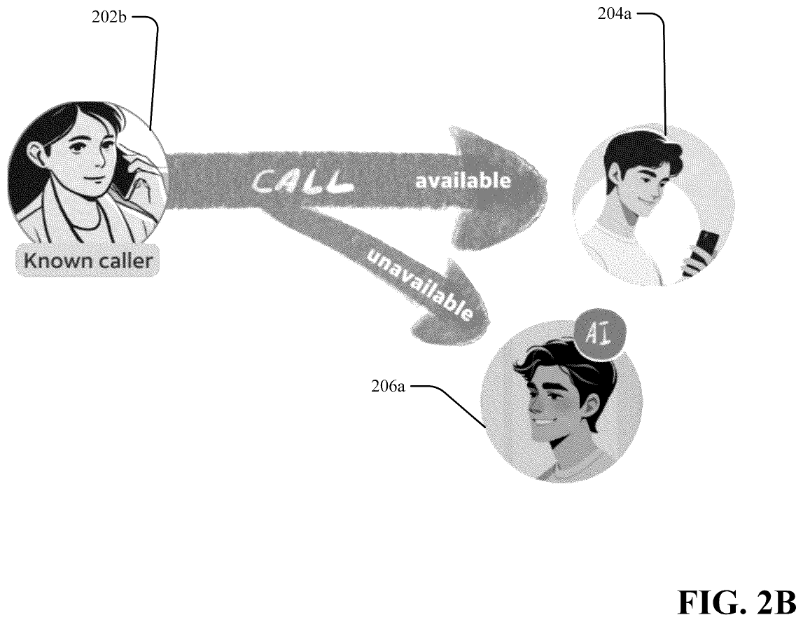

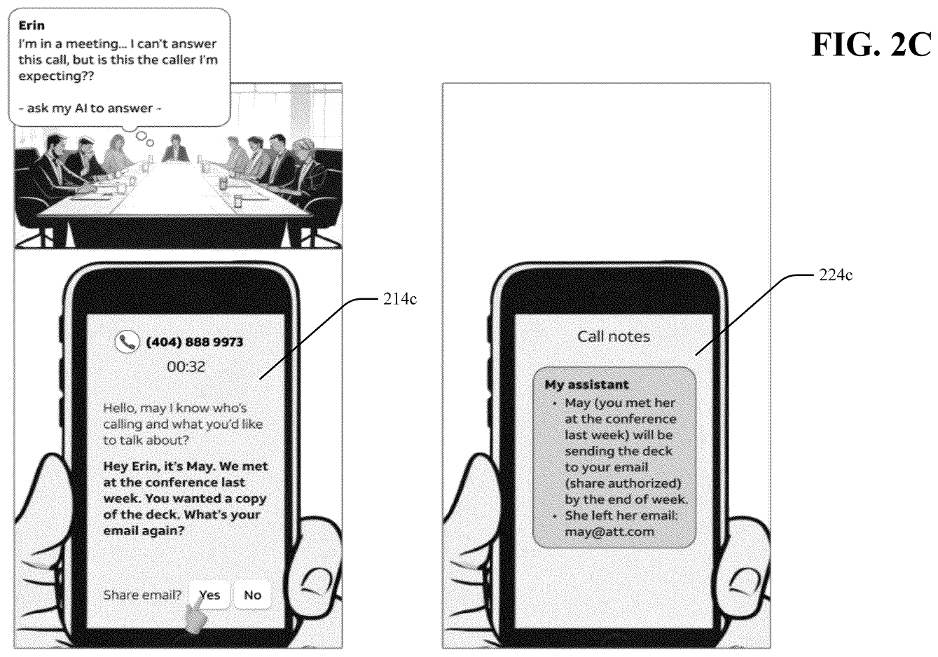

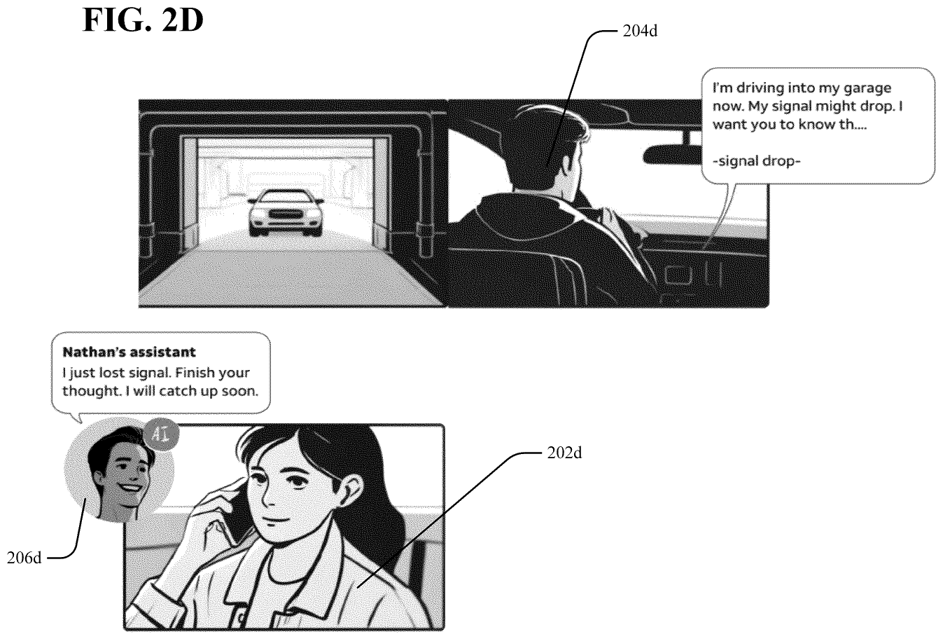

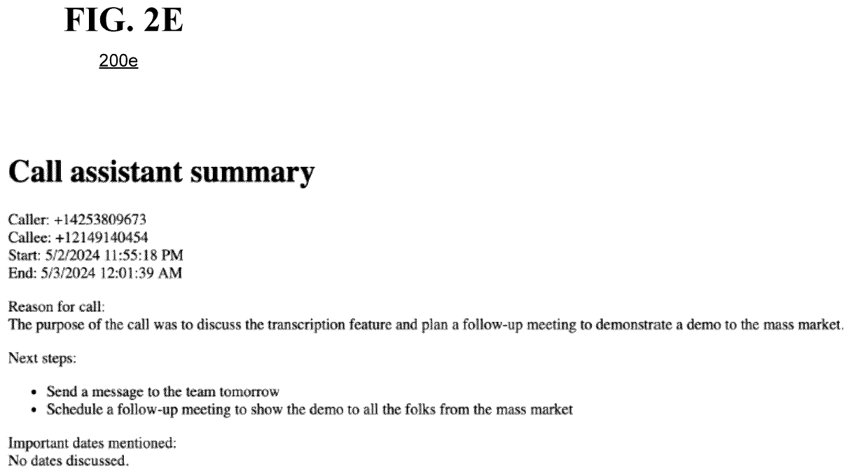

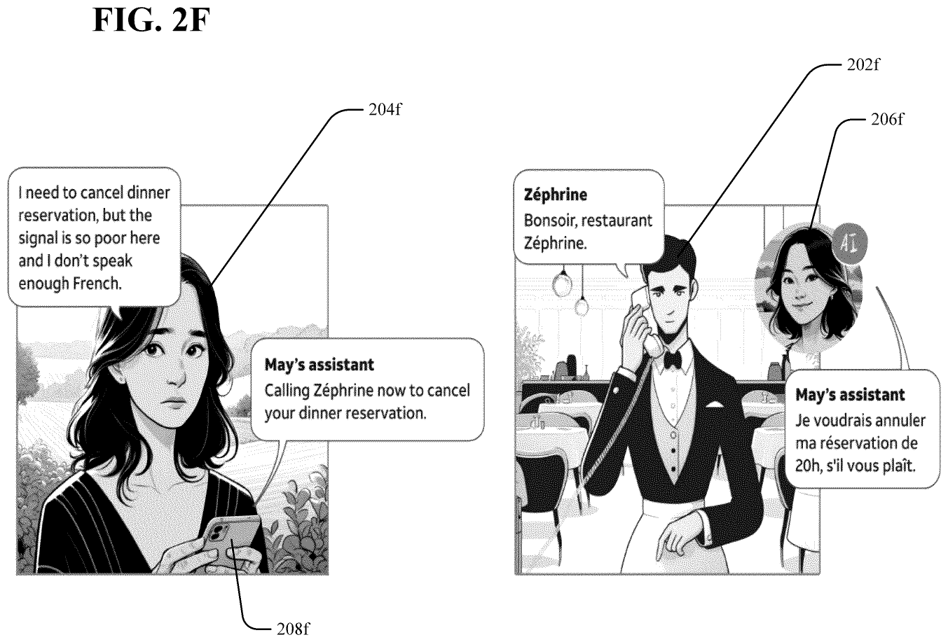

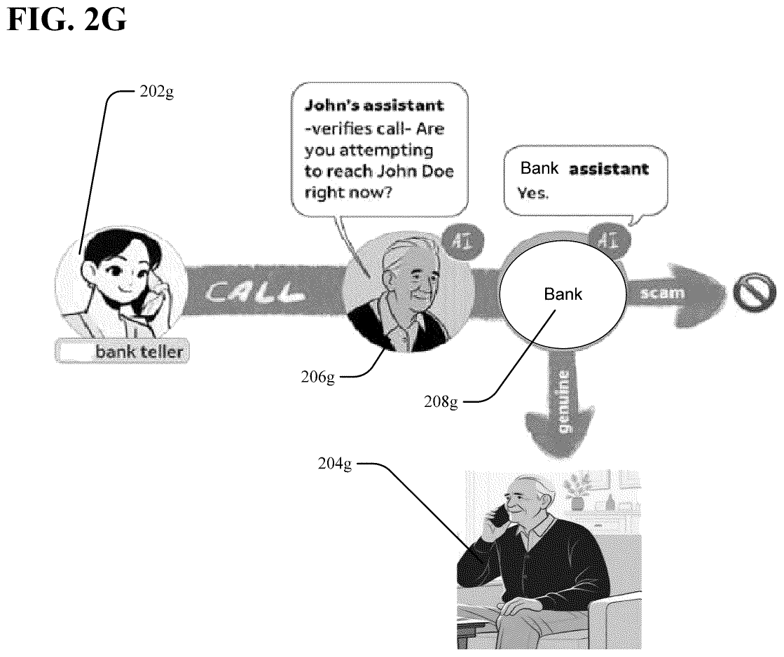

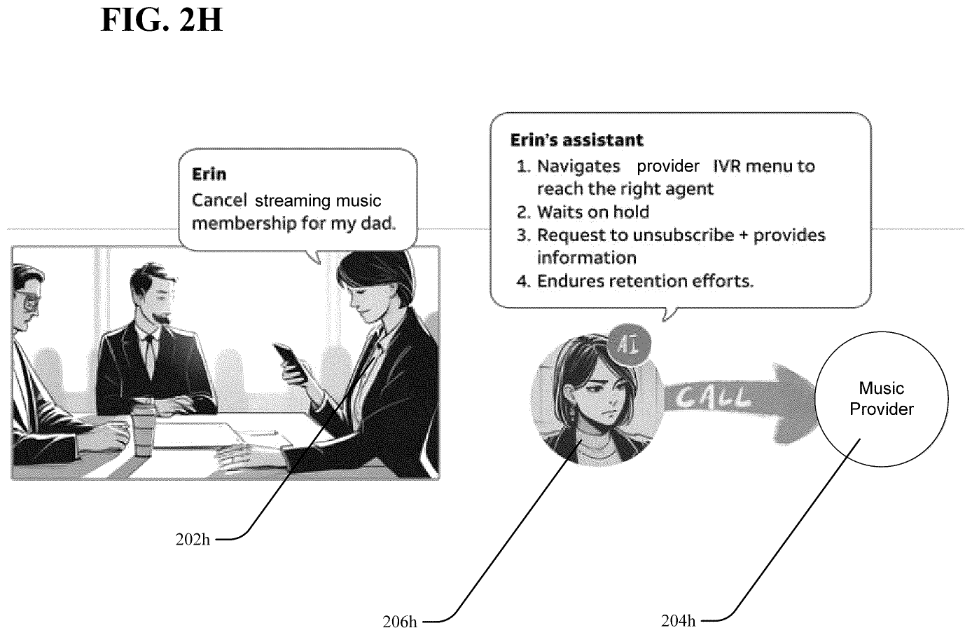

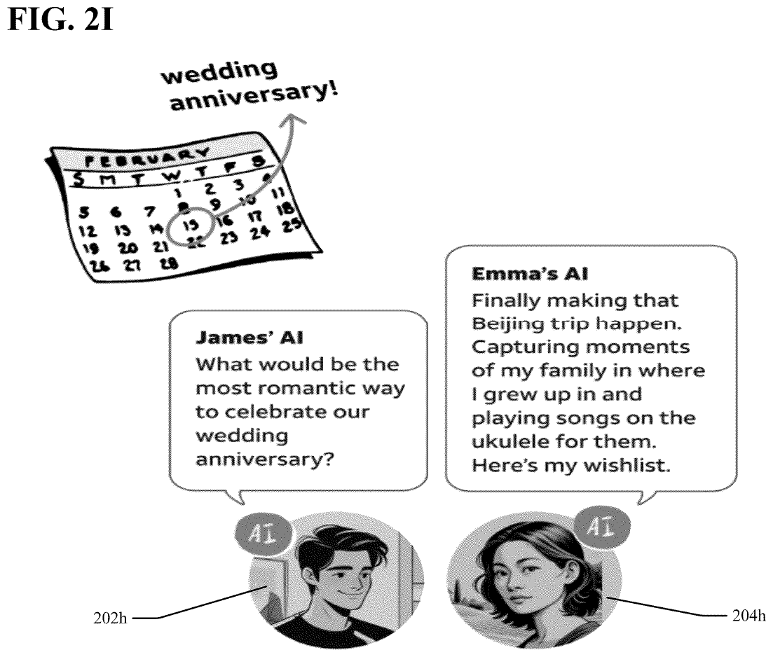

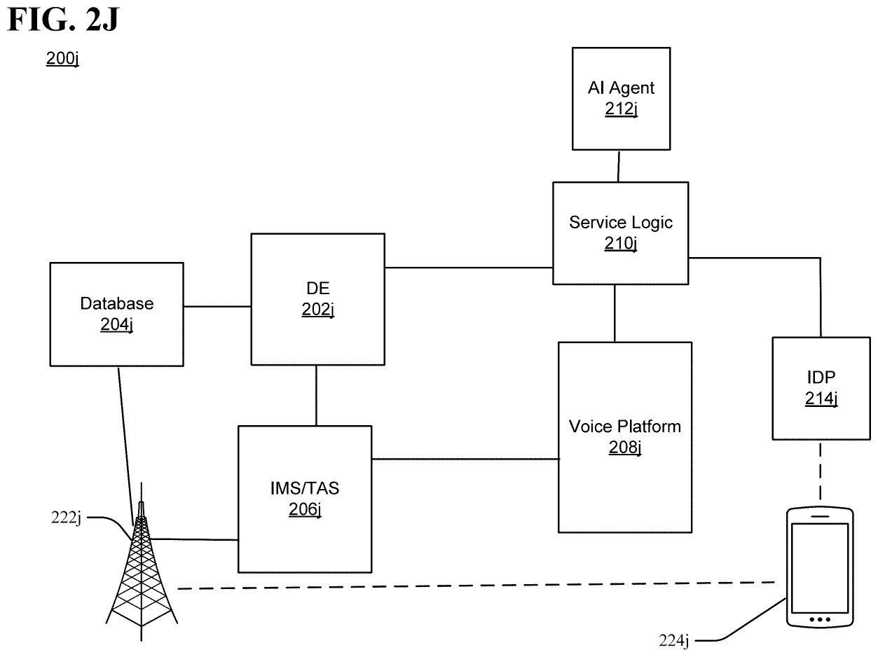

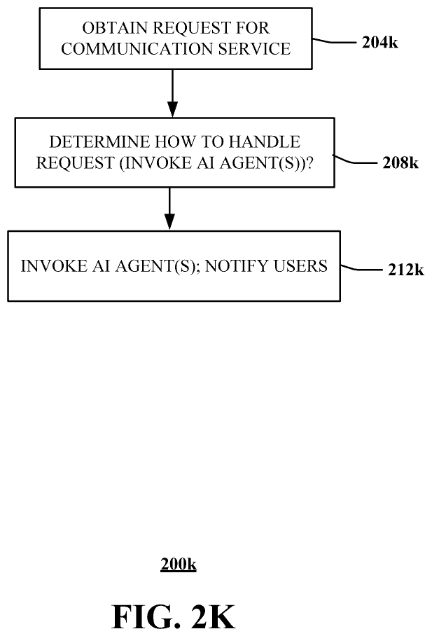

With the foregoing in mind, reference may now be made to FIG. 2A, which depicts an example of a fairly typical situation where a first user (e.g., a caller) 202a places a voice call to a second user (e.g., a callee) 204a. In this example, it may be assumed that the first user 202a is unknown to the second user 204a. Further, it may be assumed that the first user 202a is promoting a service (e.g., a lawn care service) as part of a business and is attempting to solicit new customers, and that the second user 204a resides in an apartment complex (and thus, does not have a need for lawn services).

Conventionally, the situation set forth above in respect of FIG. 2A would entail the second user 204a having to decide whether to answer the incoming voice call from the first user 202a, unsure of the nature of the voice call. For example, the second user 204a could opt to ignore or decline the incoming voice call, but would risk missing out on information that might be important to the second user 204a. Alternatively, the second user 204a could opt to answer the voice call, but may then become annoyed upon learning in conversation/discussion that the first user 202a is attempting to sell a service (lawn care) that the second user 204a does not need/desire.

To address the foregoing, aspects of this disclosure may include/provide an AI-enabled agent/assistant 206a to serve as an intermediary/interface with respect to the voice call initiated by the first user 202a. The AI agent 206a may act on behalf of the second user 204a to intercept/receive and process the voice call. For example, the AI agent 206a may ask probing questions of the first user 202a, such as “May I ask who is calling and what is the nature of your call today?” If the first user 202a fails to provide answers or provides answers that fail one or more rules that may be established by, e.g., the second user 204a, the AI agent 206a may decline to forward the voice call to the second user 204a (or a device of the second user 204a). Conversely, if the answers provided by the first user 202a satisfy the rule(s), the AI agent 206a may allow the voice call to go through and reach the device/user equipment of the second user 204a.

Thus, as this example of FIG. 2A demonstrates, aspects of an AI agent (e.g., the AI agent 206a) may provide a function of call-screening/filtration with respect to callers that are unknown to a callee. The functionality may be resident at the network/system level, which is to say that a user's device (e.g., a user equipment of the second user 204a) might not even be bothered or aware that the first user 202a called if, for example, the voice call fails one or more rules or criteria. Of course, in some embodiments the second user 204a may still have access to a log, record, or the like that may signify that the first user 202a attempted to call/called the second user 204a.

As a variant of the example of FIG. 2A described above, in another example as shown in FIG. 2B it may be assumed that a first user 202b is known to the second user 204a. However, it may be the case that the second user 204a does not always want to talk to the first user 202b. For example, the second user 204a might not prefer to talk to the first user 202b late in the evening (e.g., after 8 PM) unless the nature/topic of the conversation is “very important” or the second user 204a is “in a really good mood”. Thus, in the example of FIG. 2B it may be the case that the AI agent 206a may selectively route a voice call initiated by the first user 202b to the user equipment of the second user 204 a at 9 PM if the conversation is about “the important topic of keeping the second user's children safe” or the second user is “joyful due to receiving a promotion at work” (as potentially expressed by the second user 204a on a social media application/website). Conversely, if the topic of the conversation initiated by the first user 202b is relatively mundane and the second user 204a is in an average-to-bad mood, the AI agent 206a may block/reject the call initiated by the first user 202b from reaching the second user 204a, may handle the call (such as, for example, taking down information and forwarding the information to the second user 204a for the second user's consumption at a later point in time), etc.

Thus, as this example pertaining to FIG. 2B demonstrates, aspects of an AI agent (e.g., the AI agent 206a) may provide a function of call-screening/filtration with respect to callers that are known to a callee. More specifically, as this example demonstrates, context may be used to decide whether a call should be allowed to reach a callee (e.g., the second user 204a). This may be contrasted with conventional techniques that merely look at a phone number of a caller to block the caller or flag the caller as suspect/spam. From the perspective of a callee, and based on context, a legitimate caller in one instance may be a spam or nuisance caller in another instance; aspects of this disclosure may be used to differentiate/distinguish between these two instances.

Referring now to FIG. 2C, another example is shown where a user (named Erin) is in a meeting and is unable to answer a voice call. It may be assumed that Erin was awaiting a voice call from another user (named May), and unfortunately Erin cannot answer due to being in the meeting. Thus, as shown in FIG. 2C, an AI agent of this disclosure may answer the voice call from May on behalf of Erin and may take a message from May. May may indicate in her message that she has a copy of a deck (e.g., a slide or presentation deck) that Erin inquired about at a conference last week, and wants to know what Erin's email address is to be able to email Erin the deck. As shown in FIG. 2C, a message may be displayed on Erin's device/user equipment 214c that explains to Erin the nature of May's call, and provides an option for Erin to share her email address with May (to, e.g., enable May to send the deck to Erin). As shown in FIG. 2C, and perhaps after the meeting Erin was involved in ends or following May's engagement with Erin's AI agent, Erin may obtain call notes or a summary of the activity that the AI agent engaged in with May on behalf of Erin via a device 224c (which may be the same device as the device 214c).

As the example shown in FIG. 2C demonstrates, aspects of this disclosure may enable a user (e.g., Erin) to visualize a context associated with a voice call. Even though Erin may have been unable to directly participate in the voice call with May, Erin was still able to obtain a sense of the nature/reason behind May's call, and was able to provide timely information to May (via the AI agent) to allow May to send Erin the deck via email (e.g., May was not delayed in sending the deck to Erin simply because Erin was occupied by the meeting). Further, the example of FIG. 2C demonstrates that the AI agent was able to interpret the information May provided to solicit/query whether it was acceptable to Erin to share Erin's email address with May. Moreover, the post-call processing of May's interaction with Erin's AI agent allows Erin to catch-up and understand what the AI agent has done (or, analogously, has not done) on behalf of Erin as it relates to May. In brief, Erin may obtain a firm understanding of the nature of the interaction involving the AI agent and May without having directly engaged with May, orally, as part of the voice call.

Referring now to FIG. 2D, an example is shown where a first user 202d is speaking with a second user 204d (named Nathan). It may be the case that the second user 204d is utilizing audio equipment of a vehicle to facilitate a voice call with the first user 202d, to enable the second user 204d to engage in “hands-free” driving (in this regard, it is noted that many jurisdictions have enacted laws or regulations that prohibit a motorist from handling, e.g., a smartphone or cellphone when operating a vehicle). Upon arriving home, and parking the vehicle in a garage, it may be the case that network/system signal is impeded by the walls of the garage, such that the voice call involving the first user 202d may, using conventional technologies, abruptly end.

Aspects of this disclosure may be used to address the situation depicted in FIG. 2D. For example, upon detecting that a signal strength of the network/system signal decreases to less than a threshold (at, e.g., the location of the second user 204d), an AI agent 206d of the second user 204d may be invoked, or interject on behalf of the second user 204d, to continue the discussion with the first user 202d. Thus, as this example demonstrates, an AI agent (e.g., the AI agent 206d) may be used to “fill-in” gaps when connectivity is poor (e.g., when connectivity is “lost”). The AI agent 206d may indicate to the first user 202d that the second user 204d has lost service, may request information of the first user 202d to enable the second user 204d to respond, etc.

While the above example of FIG. 2D pertained to a degraded network/system signal triggering/initiating the use of the AI agent 206d, the triggering of the AI agent 206d may be based on other reasons (e.g., a low battery level, the second user 204d suddenly deciding to go offline (such as the second user 204d having to rush to a bathroom for an unexpected emergency), etc.). By virtue of the fact that the AI agent 206d may be hosted at the network/system level (as opposed to the communication device of the second user 204d) via network/system resources, this implies that the AI agent 206d may be available even when the second user 204d or a communication device of the second user 204d is unavailable (e.g., is powered off, has poor signal conditions, has a low battery, etc.). Continuing this example, assuming that the second user 204d leaves the vicinity of the garage (e.g., exits the vehicle upon parking the vehicle in the garage), and the signal conditions associated with a handheld device of the second user 204d improve, it may be the case that the AI agent 206d may hand-off the call involving the first user 202d (back) to the second user 204d. As part of that hand-off, the AI agent 206d may provide a summary of what was shared with/by the first user 202d during the time period that the second user 204d was not actively speaking with the first user 202d. In this manner, the first user 202d might not be inconvenienced with, or annoyed by, having to repeat/rehash what the first user 202d shared with the AI agent 206d. Stated differently, the AI agent 206d may gracefully assume the role of the second user 204d when the second user 204d is unavailable, and may seamlessly help to re-install/re-insert the second user 204d into the conversation with the first user 202d when the second user 204d is able to do so.

Referring now to FIG. 2E, an example is shown of a call transcript and summary 200e that may be generated by an AI agent in conjunction with a voice call. The transcript and summary 200e may identify the caller and callee, start and end dates/times, etc. Natural language processing (NLP) techniques, keyword identification techniques, and the like, may be utilized to generate information regarding, e.g., the reason for the call, as part of the transcript and summary 200e. Context presented during the call, as well as other information/data, may be analyzed to identify additional action items or next steps (e.g., sending a message to a team of persons/people, scheduling a follow-up meeting, etc.) as part of the transcript and summary 200e.

The example shown in FIG. 2E demonstrates that an AI agent may help users focus on tasks at hand during discussions/conversations, without having to be burdened by taking accurate notes or records of what is being discussed. Stated differently, an AI agent may be able to alleviate the burden on users having to jot down key points or action items as part of, e.g., meetings, enabling users to focus their attention on the substantive aspects of the discussion. High-level summaries, as well as line-by-line transcription, may be provided so that major points as well as subtle or fine details do not get lost or overlooked. Follow-up activities may be automatically scheduled or initiated by the AI agent, such that the users might not be burdened with having to manually enter or engage in such activities.

Referring now to FIG. 2F, an example of an AI agent being used to bridge language barriers or difficulties is shown. In particular, it may be assumed that a first user 202f is an owner or employee of a restaurant (named Zéphrine) in France. A second user (named May) 204f that resides in the United States may be visiting France, and may have an entry on her calendar indicating that she has a dinner reservation at Zéphrine. May may interact with her AI agent 206f, in the English language, to request that the dinner reservation at Zéphrine be cancelled. For example, May may initiate the request orally, via an application, etc., on May's device 208f. The AI agent 206f may initiate a voice call to Zéphrine, and may advise the first user/employee 202f of Zéphrine, in the French language, that May is not going to be attending Zéphrine for dinner per the reservation.

As the example of FIG. 2F demonstrates, aspects of an AI agent may be used to provide or deliver a multi-turn message in any language. In some embodiments, an AI agent may facilitate voice calls with live or (substantially) real-time translation, meaning that parties to a voice call might not be fluent in one another's tongues or languages, and yet all the parties will be able to understand one another.

Referring now to FIG. 2G, an example of AI agents being used to effectively authenticate users to one another is shown. In FIG. 2G, it may be assumed that a first user (e.g., a teller) 202g is affiliated with a bank (or other business or institution) and is looking to speak to a second user (named John) 204g. For example, it may be the case that the teller is looking to advise John of a change being made to John's checking account with the bank. Conventionally, and to protect John's privacy, the teller may ask John for identifying information (e.g., last four digits of a social security number, mother's maiden name, etc.) that would typically only be known by John. However, John may be reluctant to share that information with the teller, as John may be skeptical that the teller is who she says she is/claims to be. In this regard, aspects of this disclosure may utilize AI agents (e.g., an AI agent 206g associated with John and an AI agent 208g associated with the teller or bank) to authenticate one another. Any number of techniques may be utilized as part of the authentication procedure. Further, it is noted that since the authentication is being performed/conducted between AI agents 206g/208g (or other artificial, non-human computational hosts) that the authentication can occur in any number of ways—e.g., the authentication can be based on an exchange of non-verbal, electronic data or information. In this respect, the authentication may be even more robust than conventional techniques (e.g., answering questions about social security numbers, mother's maiden name or the like). Assuming that the authentication procedure is successfully completed, the call initiated by the teller 202g may be enabled to reach a communication device of John 204g. Conversely, if the authentication procedure fails, the call initiated by the teller 202g may be rejected or blocked, to protect the interests of the teller/bank and/or John.

Referring now to FIG. 2H, an example of an AI agent being used to terminate a subscription is shown. For example, it may be the case that a provider 204h of a streaming music service has made it ‘difficult’ for subscribers to cancel plans. In the particular example of FIG. 2H, it may be the case that a first user (named Erin) 202h invokes her AI agent 206h to cancel a subscription/membership that Erin's dad has. The AI agent 206h may be able to determine/identify (based on historical data, for example) who Erin's dad is, and may determine that Erin is authorized to act on behalf of her dad (based, for example, on a relationship of trust between Erin and her dad). In view of the same, the AI agent 206h may undertake a number of operations or functions, such as: calling the music provider/service 204h, navigating a call tree or interactive voice response (IVR) menu to reach an agent of the provider 204h, waiting on hold, requesting that the dad be unsubscribed or unenrolled, providing any information needed to facilitate the unenrollment process, and enduring any retention efforts that the agent of the provider 204h may undertake.

As the foregoing example in respect of FIG. 2H demonstrates, AI agents of this disclosure may be able to: navigate complex menus, wait in a ‘virtual’ line, connect and interact with real people, and complete tasks (e.g., cancelling a membership). From the perspective of the music provider 204h, it may be the case that the music provider 204h (or a device or entity associated therewith) is able to discern that an AI agent 206h has initiated the communication; based on the same, the music provider 204h may provide a different (e.g., a simplified) IVR menu to facilitate the cancellation of the subscription/membership. For example, based on a determination that the AI agent 206h is involved, the music provider 204h might not even put a live representative/human in contact with the AI agent 206h; e.g., the music provider 204h may automate the procedure for cancellation of the subscription/membership. In another instance, the agent of the provider 204h might not even bother to engage in retention efforts knowing that the AI agent 206h is involved.

Referring now to FIG. 2I, an example of AI agents being used to negotiate on behalf of respective users is shown. In particular, in FIG. 2I it may be assumed that a first user (named James) and a second user (named Emma) are husband and wife, and their AI agents are shown via reference characters 202h and 204h, respectively. Further, it may be understood or known (by way of a calendar, or otherwise) that their wedding anniversary is February 15^{th}. Knowing this, the AI agents 202h and 204h may arrange for James and Emma to celebrate their wedding anniversary, potentially without even directly involving James or Emma. For example, it may be the case that while James would prefer to spend the anniversary in Honolulu, Hawaii that Emma longs to show James what it was like for Emma to grow up in Beijing, China. Given that the couple spent their summer vacation in Montana (which is where James wanted to go in the summer), the AI agents 202h and 204h may determine that fairness dictates spending the anniversary where Emma wants to go. One or both of the AI agents 202h and 204h may book airfare/airline tickets for James and Emma to fly to China on February 13^{th}. Further, the AI agent 202h may provide suggestions to James based on, e.g., a profile associated with Emma for James to make the anniversary special. For example, the AI agent 202h may provide an indication of a ukulele available for purchase that is on Emma's wishlist, a link to lyrics of Emma's favorite song, etc. This way, on their wedding anniversary, James may be prepared to gift the ukulele to Emma and sing along to Emma's playing of her favorite song on the ukulele.

The example set forth above in respect of FIG. 2I demonstrates that AI agents may be capable of performing tasks, potentially without specific or direct instructions from users. Further, AI agents may be able to negotiate terms or conditions with one another on behalf of users.

In some embodiments, a user that is engaged in a voice call may want advice or a recommendation on how to proceed. Thus, if a first user and a second user are partaking in a voice call, the first user may (orally) communicate with an AI agent of the first user about how to explore a sensitive subject/topic with the second user. The first user's discussion with the AI agent of the first user might not be conveyed to the second user; in this respect, the first user's interactions with the AI agent may be referred to herein as a sidebar in the sense that the first user's interactions with the AI agent may be secondary/supplemental to the first user's discussion with the second user. Based on the inquiry, and any context associated with the discussion between the first user and the second user, the AI agent of the first user may advise the first user how to broach the sensitive topic with the second user. In another example, the AI agent may be utilized by the first user to fact-check or verify the validity of an assertion made by the second user during the discussion.

Aspects of this disclosure may break/dissect a voice call into discrete components or building blocks. For example, in advance of a call there may be determinations made regarding how a user is identified (e.g., via a MSISDN), how the call is configured (e.g., via an application or web interface, via an automotive interface, etc.), languages that may be used, and any personalization that is to be provided (e.g., user or device preferences, distinctions between personal data and publicly-accessible data, authentication procedures that are to be used, etc.). During a call, natural language processing techniques, audio and/or visual cues, etc., may be analyzed to determine or decipher user intent or emotion, translation services may be provided, media may be provided or suggested, transactions or purchases may be recommended or facilitated/completed, etc. After a call, a call summary or transcript may be generated, actions may be initiated or scheduled, user or device preferences may be updated (potentially as part of a profile), models or algorithms that may drive decision-making processes/logic may be modified/updated to incorporate developments during the call, etc.

Referring now to FIG. 2J, a system 200j in accordance with various aspects of this disclosure is shown. In some embodiments, one or more parts/portions of the system 200j may be combined with, or operatively overlaid upon, one or more parts/portions of the system 100 of FIG. 1. The system 200j may include a number of devices or entities, such as for example a decision engine (DE) 202j, one or more databases (e.g., a database 204j), an IP Multimedia System (IMS) and telephony application server (TAS) 206j, a voice platform 208j, service logic 210j, an AI agent 212j, an identity provider (IDP) 214a, a base station or tower 222j, and one or more client devices/user equipment (e.g., a smartphone 224j).

The DE 202j may function as an enhanced application server that may be responsible for determining if AI services should be enabled for an inbound or outbound voice call. The voice platform 208j may act as a logical endpoint for terminating signaling and generating consumable events. The service logic 210j may integrate various AI services on a (mobile) subscriber's behalf. The service logic 210j may consume signaling events or media generated on/by, e.g., the voice platform 208j and may invoke AI or large language model (LLM) supported services, such as AI-based call screening, AI-generated voice detection, etc. The service logic 210j may provide support for, e.g., the smartphone 224j to share information about an ongoing call being screened via AI and to enable a user or subscriber associated with the smartphone 224j to direct the behavior of AI.

The IDP 214a may mediate communications between the smartphone 224j and the service logic 210j. In some embodiments, the IDP 214a may responsible for managing and storing digital identifiers for users, devices, and other entities. In some embodiments, the IDP 214a may be used to authenticate users or devices, potentially in relation to websites, applications, services, and the like. The IDP 214a may include one or more security components or algorithms that may thwart attempts at intrusion or access to sensitive areas or resources.

The AI agent 212j may include a set of AI services for understanding multimodal inputs (e.g., speech, text, images, video, audio, etc.) and generating appropriate responses for an interface used by a user or subscriber. The AI agent 212j may be responsible for maintaining and utilizing specific contexts for users or subscribers. The AI agent 212j may run/execute models for identifying synthetic voices, scams/phishing attempts, and the like.

The database 204j may be used to store data or metadata pertaining to user preferences, network/system parameters (e.g., parameters pertaining to key performance indicators (KPIs), quality of service (QoS), quality of experience (QoE), etc.), summaries or transcripts of communications (e.g., voice calls), etc. Data or information available in the database 204j may include information pertinent to a particular user or device, publicly accessible information, social media information, purchase/transaction information, etc. The data or information may be used by, e.g., the DE 202j, the service logic 210j and/or the AI agent 212j to facilitate decision-making processes or logic.

The arrangement and functionality set forth above in respect of the system 200j is exemplary, which is to say that different arrangements may be used in some embodiments, and functionality may be reallocated from a first device or entity to one or more other devices or entities without departing from the scope and spirit of this disclosure. In this regard, one or more of the devices, entities, or functions described above in respect of the system 200j may be optional, and additional devices, entities, or functions not shown or described in respect of the system 200j may be included in a given embodiment.

Referring now to FIG. 2K, an illustrative embodiment of a method 200k in accordance with various aspects described herein is shown. The method 200k may be implemented or executed, in whole or in part, in conjunction with one or more systems, devices, and/or components, such as for example the systems, devices, and components set forth herein. In some embodiments, the method 200k may be wholly or partially implemented or executed via one or more processing systems, where each such processing system may include one or more processors. Further, in some embodiments, operations of the method 200k may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200k are described below in relation to the blocks shown in FIG. 2K. In some embodiments, one or more blocks or operations may be based on one or more other blocks or operations.

In block 204k, a request for/in respect of a communication service may be obtained. For example, the request of block 204k may be based on a first user initiating a voice call that is directed to a second user.

In block 208k, a determination may be made regarding how to handle the communication request. For example, block 208k may include a determination of whether an AI agent is to be invoked, to what extent/degree the AI agent is to participate, etc. Block 208k may be based on user preferences, rules or policies, etc. The method 200k is described further below based on the determination of block 208k indicating that an AI agent is to participate, with the understanding that if an AI agent is not to participate that the call may be handled as would be customary/typical in the current state of the art.

In block 212k, one or both of the first user and the second user may be notified that a respective AI agent has been invoked and is participating in the communication service. As part of block 212k, one or more AI agent supported services or functions may be provided or executed, such as the services and functions described above in respect of FIGS. 2A-2I. For example, the AI agent of the second user (e.g., the callee) may perform call screening and/or authentication before deciding to signal/notify/ring a communication device of the second user of the call initiated by the first user (e.g., the caller).

While for purposes of simplicity of explanation, the respective processes are shown and described as a series of blocks in FIG. 2K, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Various types of signaling may be supported by the system 200j and/or the method 200k to facilitate establishing and maintaining a communication session between two or more users or devices. For example, aspects of this disclosure may facilitate initiating or establishing a communication session, handing over a communication session, terminating a communication session, etc. As is customary, different entities of a communication network or system may participate in such signaling to enable communication services to be provisioned.

Aspects of this disclosure facilitate establishing and using AI agents for achieving/satisfying various purposes or objectives. Functionalities supportive of an AI agent may operate in accordance with a principle of network/system embeddedness, whereby decision-making processes and logic may be removed from a client device/user equipment. In this manner, the decision-making processes and logic may leverage the expansive computational power/resources of the network/system, and may ensure that an AI agent is potentially available all hours of the day, even when a user or associated client device/user equipment is powered-down, offline, or otherwise unavailable/inaccessible. Furthermore, an AI agent of this disclosure may be tied to a user identifier (e.g., a phone number, a username, a personal identification number, a biometric credential, etc.), such that the AI agent may be easily ported/transferred to whatever device(s) or application(s) that a user elects to use. Functions or computational hosts supportive of an AI agent may be located near an edge of a communication network or system to facilitate reliable, low latency operations (e.g., real-time or near real-time operations).

Aspects of this disclosure may leverage a variety of information and data sources to provide high-quality, high-accuracy solutions for facilitating an AI agent. An AI agent of this disclosure may be used to provide answers to difficult questions, and may even be used to provide answers or recommendations/suggestions to questions that users have not necessarily even thought to ask. Functions supported by an AI agent of this disclosure may tend to make users lives easier by alleviating users of burdens associated with various tasks, thereby enabling such users to lead more efficient and productive lives.

In some embodiments, an AI agent may be implemented or administered as a standalone application. In other embodiments, an AI agent may supplement or serve as a rider on top of an existing application. A network/system operator or service provider may charge a licensing or subscription fee to utilize an AI agent. Various suites of functions or libraries that may be available for an AI agent may potentially be accessible to users based on a payment of a licensing fee.

Machine learning, artificial intelligence, and/or the use of one or more models or algorithms may facilitate an AI agent of this disclosure. In some embodiments, modifications to an AI agent may be subject to one or more controls or regulations to avoid exposing confidential or sensitive information, to avoid an AI agent taking an inappropriate or unauthorized action, etc.

As demonstrated herein, the various aspects of this disclosure involving an AI agent may be used as part of numerous practical applications to generate transformational, useful, concrete, and tangible results. The various aspects of this disclosure directly touch on, and improve, underlying computing technologies in relation to a provisioning of various types of services, including various types of communication services (e.g., videoconferencing, voice calls, text messaging sessions, etc.). In this regard, and as demonstrated herein, the various aspects of this disclosure represent substantial improvements to technology. In brief, and as one of skill in the art will appreciate based on a review of this disclosure, the various aspects of this disclosure are not directed to abstract ideas. To the contrary, the various aspects of this disclosure are directed to, and encompass, significantly more than any abstract idea standing alone.

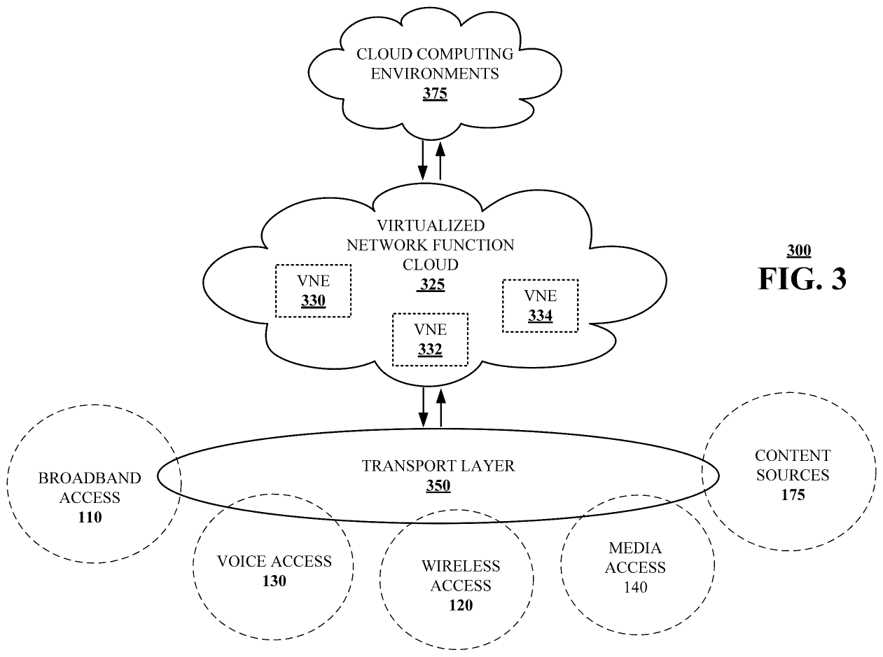

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200j, and method 200k presented in FIGS. 1, 2J, and 2K. For example, the virtualized communication network 300 can facilitate, in whole or in part, obtaining a request for a communication service including a voice call, determining, based on the obtaining of the request, that an artificial intelligence (AI) agent is to support the communication service, and embedding, based on the determining, at least a first AI agent within a resource of a communication network to provide support for the communication service. The virtualized communication network 300 can facilitate, in whole or in part, invoking a first artificial intelligence (AI) agent in respect of a first resource of a first carrier to support a communication service for a first user, and based on the invoking, interacting, via the first AI agent, with a second user as part of the communication service. The virtualized communication network 300 can facilitate, in whole or in part, obtaining, by a processing system including a processor, an indication of a first voice call initiated by a first user and directed to at least a second user, invoking, by the processing system and based on the obtaining of the indication of the first voice call, an artificial intelligence (AI) agent to answer the first voice call on behalf of the second user, determining, by the processing system and based on the invoking of the AI agent to answer the first voice call, a first purpose of the first user in initiating the first voice call, determining, by the processing system, that the first purpose satisfies a preference of the second user, and notifying, by the processing system and based on the determining that the first purpose satisfies the preference of the second user, a communication device of the second user of the first voice call.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

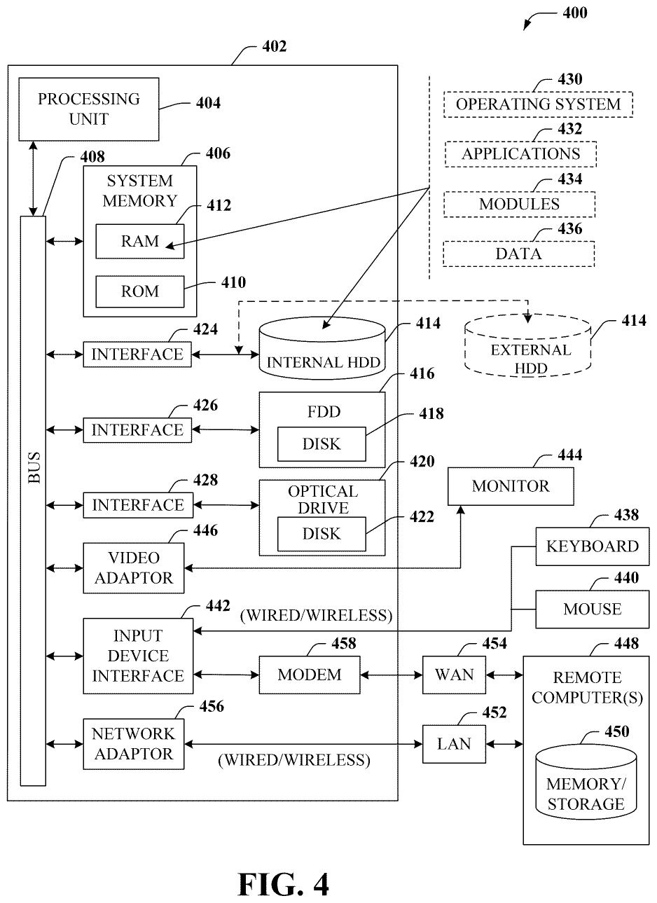

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining a request for a communication service including a voice call, determining, based on the obtaining of the request, that an artificial intelligence (AI) agent is to support the communication service, and embedding, based on the determining, at least a first AI agent within a resource of a communication network to provide support for the communication service. The computing environment 400 can facilitate, in whole or in part, invoking a first artificial intelligence (AI) agent in respect of a first resource of a first carrier to support a communication service for a first user, and based on the invoking, interacting, via the first AI agent, with a second user as part of the communication service. The computing environment 400 can facilitate, in whole or in part, obtaining, by a processing system including a processor, an indication of a first voice call initiated by a first user and directed to at least a second user, invoking, by the processing system and based on the obtaining of the indication of the first voice call, an artificial intelligence (AI) agent to answer the first voice call on behalf of the second user, determining, by the processing system and based on the invoking of the AI agent to answer the first voice call, a first purpose of the first user in initiating the first voice call, determining, by the processing system, that the first purpose satisfies a preference of the second user, and notifying, by the processing system and based on the determining that the first purpose satisfies the preference of the second user, a communication device of the second user of the first voice call.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

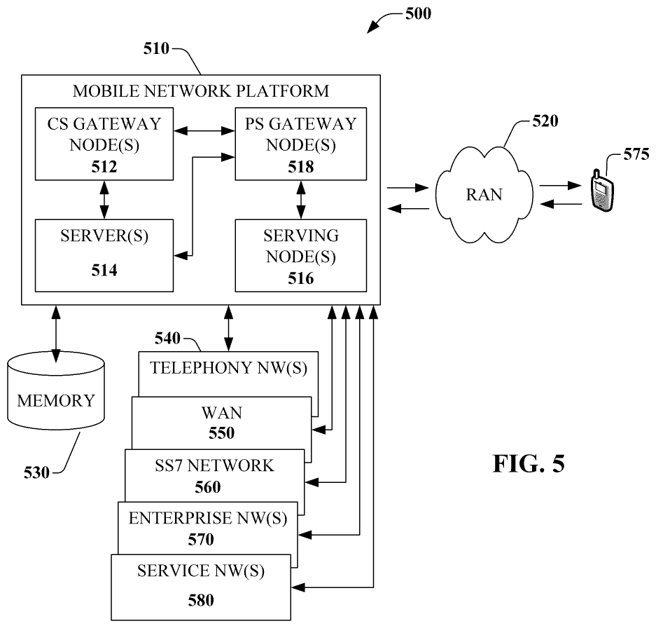

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining a request for a communication service including a voice call, determining, based on the obtaining of the request, that an artificial intelligence (AI) agent is to support the communication service, and embedding, based on the determining, at least a first AI agent within a resource of a communication network to provide support for the communication service. The platform 510 can facilitate, in whole or in part, invoking a first artificial intelligence (AI) agent in respect of a first resource of a first carrier to support a communication service for a first user, and based on the invoking, interacting, via the first AI agent, with a second user as part of the communication service. The platform 510 can facilitate, in whole or in part, obtaining, by a processing system including a processor, an indication of a first voice call initiated by a first user and directed to at least a second user, invoking, by the processing system and based on the obtaining of the indication of the first voice call, an artificial intelligence (AI) agent to answer the first voice call on behalf of the second user, determining, by the processing system and based on the invoking of the AI agent to answer the first voice call, a first purpose of the first user in initiating the first voice call, determining, by the processing system, that the first purpose satisfies a preference of the second user, and notifying, by the processing system and based on the determining that the first purpose satisfies the preference of the second user, a communication device of the second user of the first voice call.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

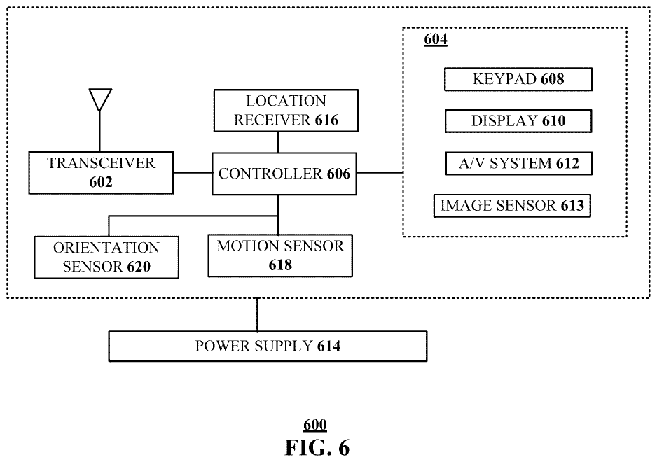

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining a request for a communication service including a voice call, determining, based on the obtaining of the request, that an artificial intelligence (AI) agent is to support the communication service, and embedding, based on the determining, at least a first AI agent within a resource of a communication network to provide support for the communication service. The computing device 600 can facilitate, in whole or in part, invoking a first artificial intelligence (AI) agent in respect of a first resource of a first carrier to support a communication service for a first user, and based on the invoking, interacting, via the first AI agent, with a second user as part of the communication service. The computing device 600 can facilitate, in whole or in part, obtaining, by a processing system including a processor, an indication of a first voice call initiated by a first user and directed to at least a second user, invoking, by the processing system and based on the obtaining of the indication of the first voice call, an artificial intelligence (AI) agent to answer the first voice call on behalf of the second user, determining, by the processing system and based on the invoking of the AI agent to answer the first voice call, a first purpose of the first user in initiating the first voice call, determining, by the processing system, that the first purpose satisfies a preference of the second user, and notifying, by the processing system and based on the determining that the first purpose satisfies the preference of the second user, a communication device of the second user of the first voice call.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ ... xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a request for a communication service including a voice call;
determining, based on the obtaining of the request, that an artificial intelligence (AI) agent is to support the communication service; and
embedding, based on the determining, at least a first AI agent within a resource of a communication network to provide support for the communication service.

2. The device of claim 1, wherein the first AI agent is associated with a callee of the voice call.

3. The device of claim 2, wherein the first AI agent performs a call screening function on behalf of the callee with respect to the voice call.

4. The device of claim 3, wherein a caller of the voice call is unknown to the callee.

5. The device of claim 3, wherein a caller of the voice call is known to the callee.

6. The device of claim 2, wherein based on the embedding, a request for information is initiated by the first AI agent and sent to a communication device of the callee, and wherein the operations further comprise:
obtaining a response to the request for information from the communication device; and
performing, via the first AI agent, a function on behalf of the callee based on the response.

7. The device of claim 6, wherein the request for information is based on a statement made by a caller of the voice call.

8. The device of claim 6, wherein a transcript of the voice call includes an indication of the function.

9. The device of claim 2, wherein the support comprises interacting with a caller of the voice call on behalf of the callee.

10. The device of claim 9, wherein the interacting with the caller is based on: a determination that a signal strength of a network signal detected by a communication device of the callee is less than a first threshold, a determination that a battery life of the communication device of the callee is less than a second threshold, a determination that the communication device is powered off, or any combination thereof.

11. The device of claim 1, wherein the support comprises generating a transcript of the voice call and initiating an action on behalf of a party to the voice call.

12. The device of claim 1, wherein the support comprises authenticating at least one party to the voice call.

13. The device of claim 12, wherein the at least a first AI agent includes a second AI agent, wherein the first AI agent is associated with a callee of the voice call and the second AI agent is associated with a caller of the voice call, and wherein the authenticating of the at least one party to the voice call comprises an authentication procedure involving the first AI agent and the second AI agent to jointly authenticate the caller and the callee.

14. The device of claim 1, wherein the support comprises terminating a subscription via a navigation of an interactive voice response (IVR) menu.

15. The device of claim 1, wherein the first AI agent is associated with a user based on a user identifier, and wherein the user identifier includes a Mobile Station International Subscriber Directory Number (MSISDN).

16. The device of claim 1, wherein the first AI agent represents an enterprise.

17. A non-transitory machine-readable medium, comprising executable instructions that, when executed by a processing system including a processor, facilitate performance of operations, the operations comprising:
invoking a first artificial intelligence (AI) agent in respect of a first resource of a first carrier to support a communication service for a first user; and
based on the invoking, interacting, via the first AI agent, with a second user as part of the communication service.

18. The non-transitory machine-readable medium of claim 17, wherein the operations further comprise:
determining that the first user has changed carriers from the first carrier to a second carrier; and
based on the determining, porting the first AI agent such that the first AI agent is invoked in respect of a second resource of the second carrier.

19. A method, comprising:
obtaining, by a processing system including a processor, an indication of a first voice call initiated by a first user and directed to at least a second user;
invoking, by the processing system and based on the obtaining of the indication of the first voice call, an artificial intelligence (AI) agent to answer the first voice call on behalf of the second user;
determining, by the processing system and based on the invoking of the AI agent to answer the first voice call, a first purpose of the first user in initiating the first voice call;
determining, by the processing system, that the first purpose satisfies a preference of the second user; and
notifying, by the processing system and based on the determining that the first purpose satisfies the preference of the second user, a communication device of the second user of the first voice call.

20. The method of claim 19, further comprising:
obtaining, by the processing system, an indication of a second voice call initiated by the first user and directed to the at least a second user;
invoking, by the processing system and based on the obtaining of the indication of the second voice call, the AI agent to answer the second voice call on behalf of the second user;
determining, by the processing system and based on the invoking of the AI agent to answer the second voice call, a second purpose of the first user in initiating the second voice call;
determining, by the processing system, that the second purpose fails to satisfy the preference of the second user; and
blocking, by the processing system and based on the determining that the second purpose fails to satisfy the preference of the second user, the communication device of the second user from receiving the second voice call.
